(19) United States
(12) Patent Application Publication
(10) Pub. No.: US 2024/0334511 A1
(43) Pub. Date: Oct. 3, 2024

(54) DUAL BAND SIGNALS

(71) Applicant: QUALCOMM Incorporated, San Diego, CA (US)

(72) Inventors: Ahmed ELSHAFIE, San Diego, CA (US); Wei YANG, San Diego, CA (US); Yuchul KIM, San Diego, CA (US)

(21) Appl. No.: 18/190,587

(22) Filed: Mar. 27, 2023

(51) Int. Cl. H04W 76/15; H04L 1/00; H04L 5/00; H04W 52/32; H04W 72/0453

(52) U.S. Cl. CPC H04W 76/15; H04L 1/0068; H04L 5/0048; H04W 52/325; H04W 72/0453

(57) ABSTRACT

Various aspects of the present disclosure generally relate to wireless communication. In some aspects, a user equipment (UE) may receive a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal. The UE may perform an action based at least in part on the first signal. Numerous other aspects are described.

### FIELD OF THE DISCLOSURE

Aspects of the present disclosure generally relate to wireless communication and to techniques and apparatuses for dual band signals.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, a user equipment (UE) for wireless communication includes a memory and one or more processors coupled with the memory and configured to cause the UE to: receive a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal; and perform an action based at least in part on the first signal.

In some implementations, a network node for wireless communication includes a memory and one or more processors coupled with the memory and configured to cause the network node to: transmit a first signal in a frequency domain; and transmit a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal.

In some implementations, a method of wireless communication performed by a UE includes receiving a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal; and performing an action based at least in part on the first signal.

In some implementations, a method of wireless communication performed by a network node includes transmitting a first signal in a frequency domain; and transmitting a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal.

In some implementations, a non-transitory computer-readable medium storing a set of instructions for wireless communication includes one or more instructions that, when executed by one or more processors of a UE, cause the UE to: receive a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal; and perform an action based at least in part on the first signal.

In some implementations, a non-transitory computer-readable medium storing a set of instructions for wireless communication includes one or more instructions that, when executed by one or more processors of a network node, cause the network node to: transmit a first signal in a frequency domain; and transmit a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal.

In some implementations, an apparatus for wireless communication includes means for receiving a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal; and means for performing an action based at least in part on the first signal.

In some implementations, an apparatus for wireless communication includes means for transmitting a first signal in a frequency domain; and means for transmitting a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of an ultra-low-power wakeup receiver, in accordance with the present disclosure.

FIG. 5 is a diagram illustrating an example of a low-power wakeup signal (LP-WUS), in accordance with the present disclosure.

FIGS. 6-10 are diagrams illustrating examples associated with dual band signals, in accordance with the present disclosure.

FIGS. 11-12 are diagrams illustrating example processes associated with dual band signals, in accordance with the present disclosure.

FIGS. 13-14 are diagrams of example apparatuses for wireless communication, in accordance with the present disclosure.

### DETAILED DESCRIPTION

A low-power wakeup radio (LP-WUR) may be a radio receiver circuit designed to have low energy consumption. The LP-WUR may actively monitor for a low-power wakeup signal (LP-WUS). A dual band/tone LP-WUS may be useful to enhance an LP-WUS design. However, such an approach has not been sufficiently defined. A network node and/or a user equipment (UE) may not be suitably configured to support the dual band/tone LP-WUS. As a result, the network node and/or the UE may be unable to benefit from dual band/tone LP-WUSs.

In some aspects described herein, a UE may receive, from a network node, a first signal in a frequency domain. The first signal may be a low-power signal, such as an LP-WUS. Alternatively, the first signal may be a low-power synchronization signal (LP-SS) or a low-power reference signal (LP-RS). The first signal may be a dual band signal that is a function of a second signal transmitted in the frequency domain. The second signal may be a New Radio (NR) signal (e.g., a non-low-power signal). The second signal may be transmitted on a same symbol or a same set of symbols, as compared to the first signal, in the frequency domain. The UE may perform an action based at least in part on the first signal. For example, when performing the action, the UE may activate a main radio of the UE based at least in part on the LP-WUS, perform a synchronization based at least in part on the LP-SS, or track one or more of a time, a frequency, or a channel based at least in part on the LP-RS.

In some aspects, in order to support a dual band/tone low-power signal, a low-power signal, such as the first signal, may be transmitted symmetrically across a frequency. The dual band/tone low-power signal may be based at least in part on a frequency domain repetition of the low-power signal. The low-power signal may be transmitted on symmetrical frequencies. By being transmitted on symmetrical frequencies, the low-power signal may be the dual band/tone low-power signal. Such a configuration may be useful for a UE group based low-power signal when different UEs autonomously select their preferred subband to receive the same group low-power signal. Further, such a design may improve a frequency diversity.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

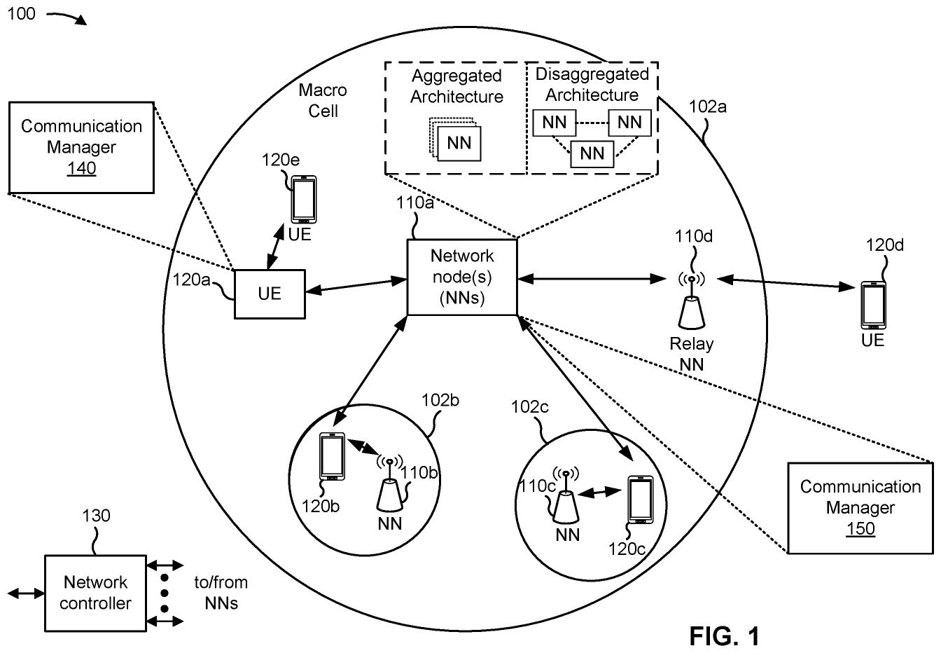

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal; and perform an action based at least in part on the first signal. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit a first signal in a frequency domain; and transmit a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal. Additionally, or alternatively, the communication manager 150 may perform one or more other operations described herein.

As indicated above, FIG. 1 is provided as an example. Other examples may differ from what is described with regard to FIG. 1.

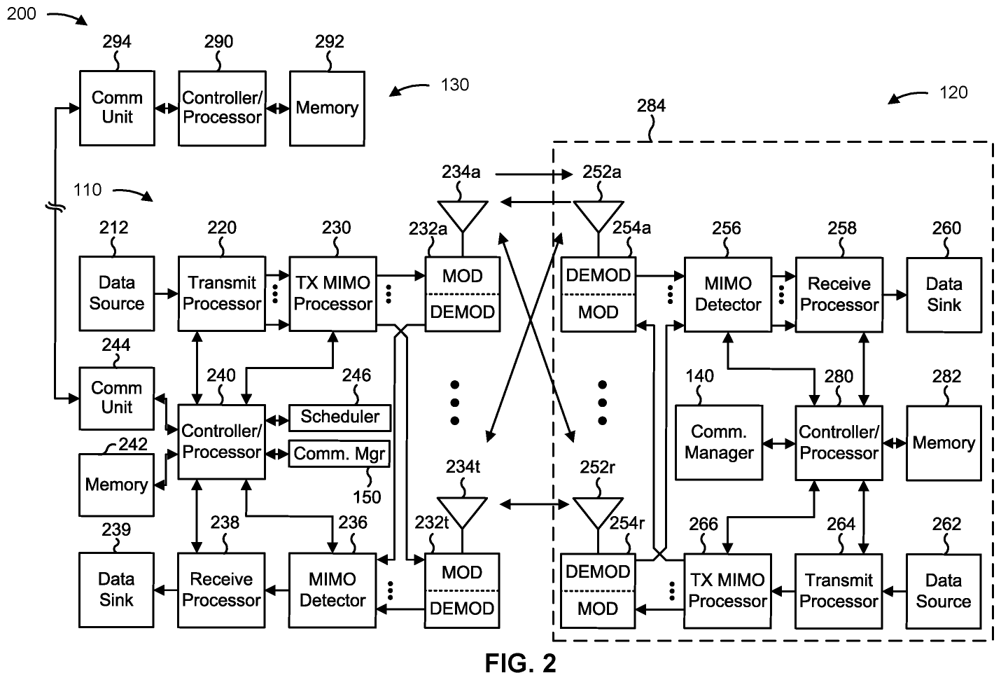

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

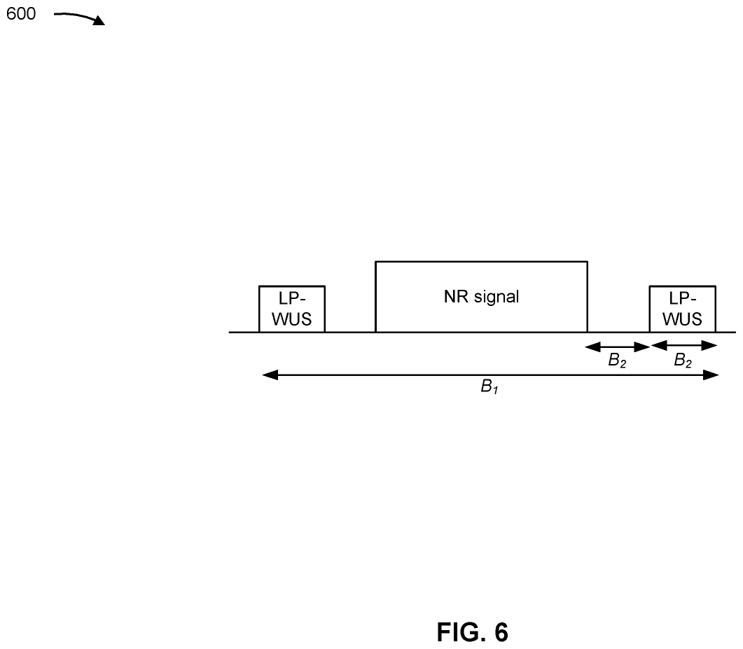

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-14).

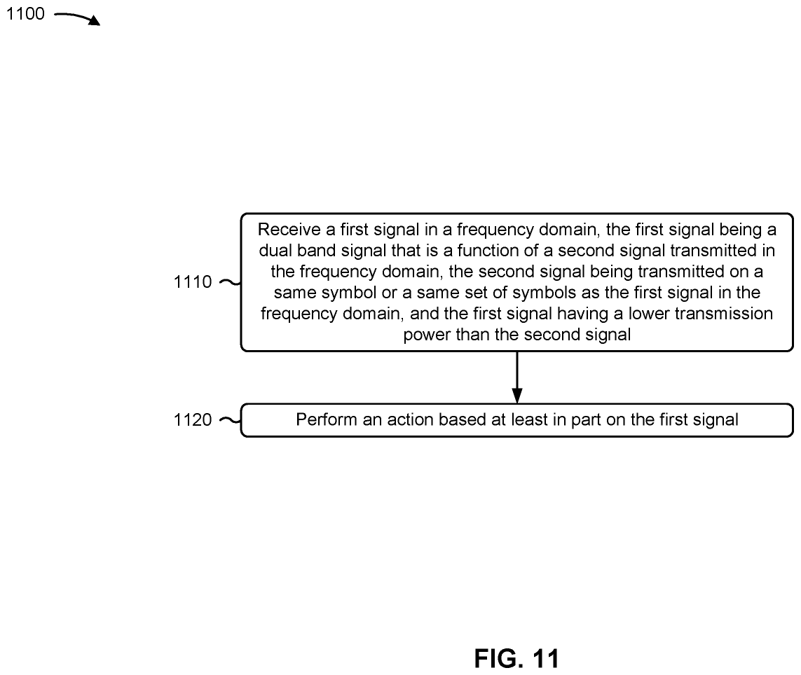

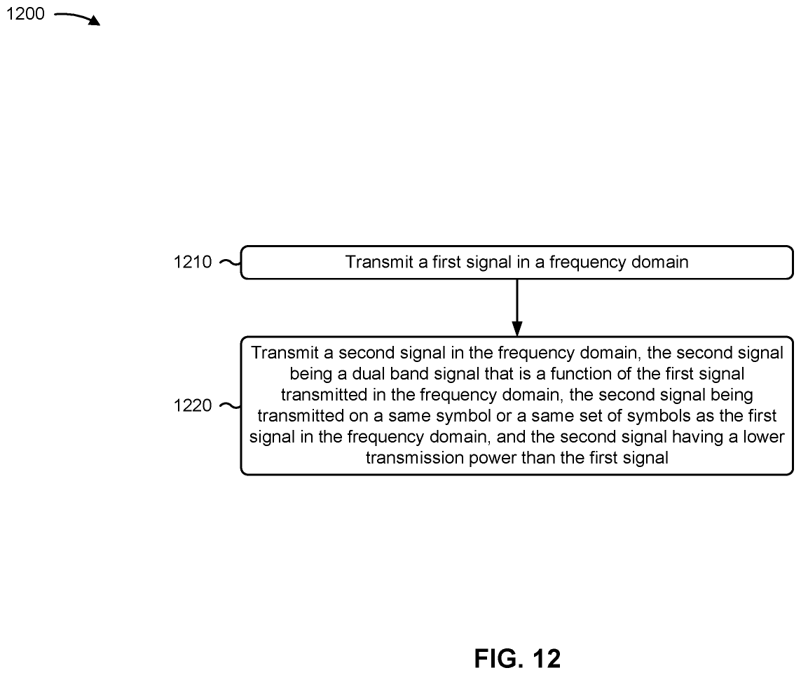

The controller/processor 240 of the network node 110, the controller/processor 280 of the UE 120, and/or any other component(s) of FIG. 2 may perform one or more techniques associated with dual band signals, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal; and/or means for performing an action based at least in part on the first signal. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting a first signal in a frequency domain; and/or means for transmitting a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

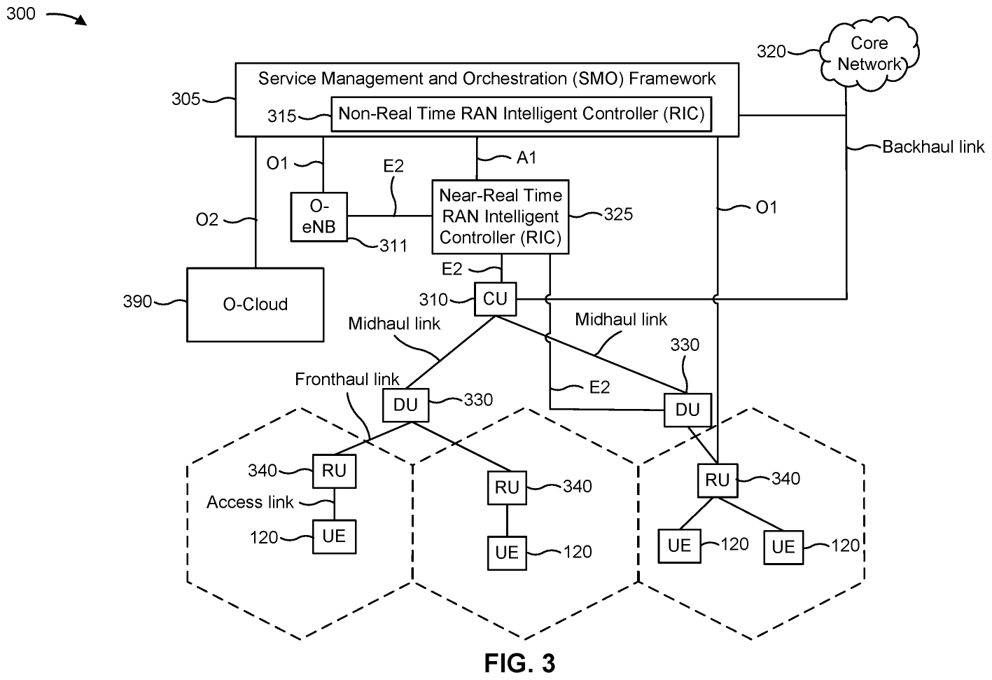

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

An LP-WUR may be a radio receiver circuit designed to have low energy consumption. When there is no data to receive, a main radio may be in an ultra-low power state (ULPS), unless there is data to transmit. The LP-WUR may actively monitor for an LP-WUS. When there is data to receive, the LP-WUR may receive an on-demand LP-WUS and activate the main radio. Data may be transmitted and received by the main radio.

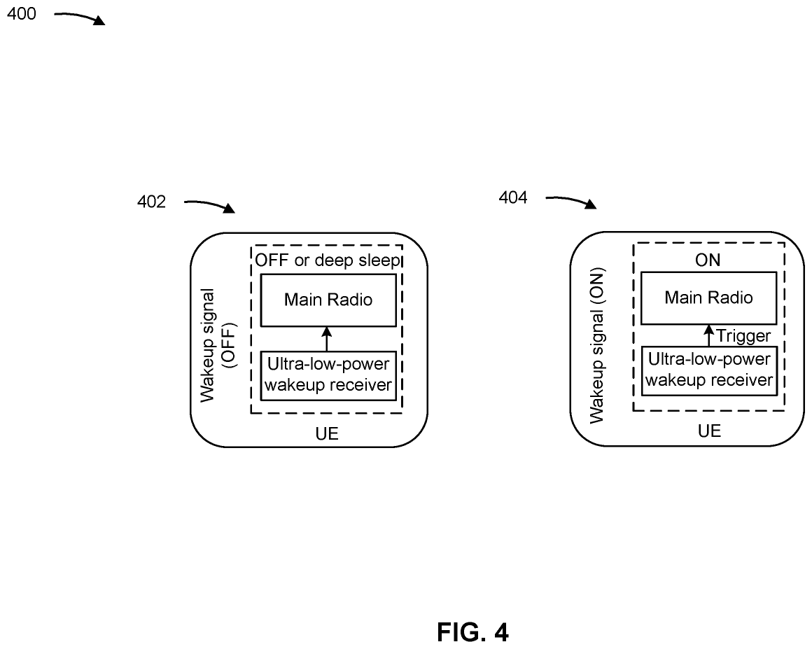

FIG. 4 is a diagram illustrating an example of an ultra-low-power wakeup receiver, in accordance with the present disclosure.

As shown by reference number 402, a UE may include a main radio and the ultra-low-power wakeup receiver. When there is no data to receive, the main radio may be off or in deep sleep, unless there is data to transmit, and the ultra-low-power wakeup receiver may keep actively monitoring for a wakeup signal. As shown by reference number 404, a UE may include a main radio and the ultra-low-power wakeup receiver. When there is data to receive, the ultra-low-power wakeup receiver may receive a wakeup signal, which may trigger the main radio to be turned on.

As indicated above, FIG. 4 is provided as an example. Other examples may differ from what is described with regard to FIG. 4.

An LP-WUS may be used to reduce unnecessary UE paging receptions. The LP-WUS may be transmitted only when there is paging for idle or inactive mode UEs. When the LP-WUS is detected, a main radio may be turned on. The main radio may monitor for a synchronization signal block (SSB) before a paging occasion (PO) for synchronization, and then may receive a paging message accordingly. When the LP-WUS is not detected, the main radio may stay in a deep sleep or in an ULPS mode for power saving.

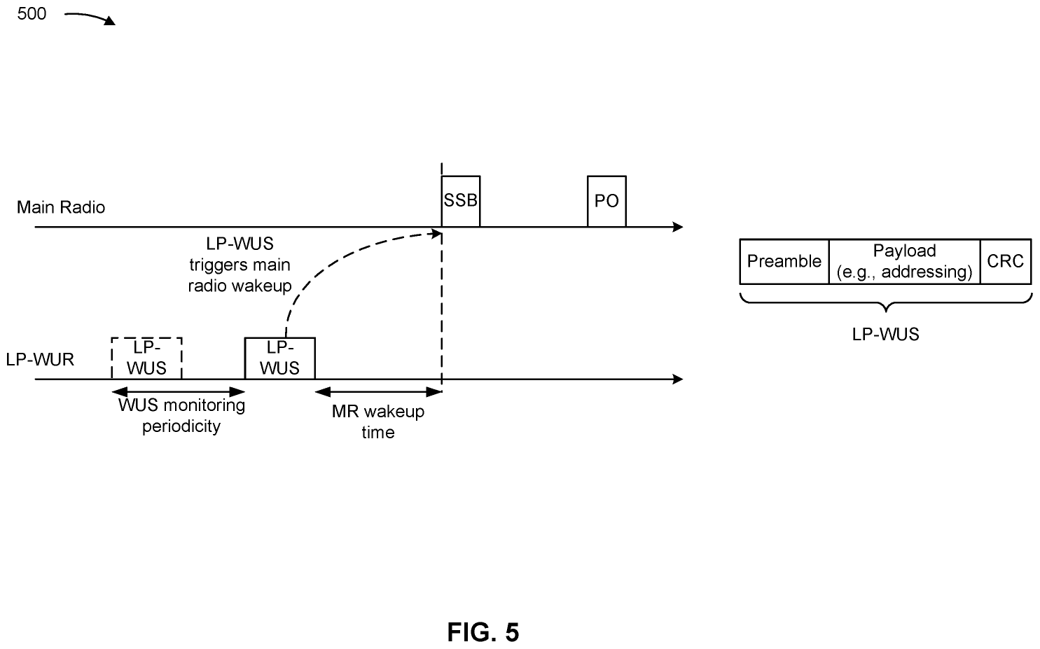

FIG. 5 is a diagram illustrating an example of an LP-WUS, in accordance with the present disclosure.

As shown in FIG. 5, an LP-WUR may monitor for an LP-WUS in according with a wakeup signal (WUS) monitoring periodicity. The LP-WUR may detect the LP-WUS. The LP-WUS may include a preamble, a payload (e.g., addressing), and a cyclic redundancy check (CRC). When the LP-WUR detects the LP-WUS, the LP-WUS may trigger a wakeup of a main radio. The main radio may wake up in accordance with a main radio wakeup time. After the main radio is turned on, the main radio may monitor for an SSB, which may be received prior to a PO.

As indicated above, FIG. 5 is provided as an example. Other examples may differ from what is described with regard to FIG. 5.

An LP-WUR may be a companion receiver that is able to monitor for a wakeup signal, with very low power, while a main radio is in a deep sleep state. The LP-WUR may wake up the main radio when actual data communication is needed. The LP-WUR may consume low power by design, and may be powered separately with less power needed, as compared to the main radio. The LP-WUR may be associated with an OFDM-based design. The LP-WUR may process an LP-WUS at baseband. The LP-WUR may reuse some main radio components to receive the LP-WUS. Alternatively, the LP-WUR may be associated with an on-off keying (OOK) based design. The LP-WUR may use an envelope detector (e.g., low intermediate frequency (IF)). The LP-WUR may be separate from the main radio. The OOK based design may provide greater power saving, as compared to the OFDM-based design.

An OFDM-compatible OOK signal may be generated using one of three options. A first option may use a time-domain OOK. A second option may use an up-sampled time-domain OOK, which may be associated with non-OOK data. A third option may use a high subcarrier spacing (SCS) and time-domain OOK mask.

A dual band/tone LP-WUS may be useful to enhance an LP-WUS design. However, such an approach has not be sufficiently defined. A network node and/or a UE may not be suitably configured to support the dual band/tone LP-WUS. As a result, the network node and/or the UE may be unable to benefit from dual band/tone LP-WUSs.

In various aspects of techniques and apparatuses described herein, a UE may receive, from a network node, a first signal in a frequency domain. The first signal may be a low-power signal, such as an LP-WUS. Alternatively, the first signal may be an LP-SS or an LP-RS. The first signal may be a dual band signal that is a function of a second signal transmitted in the frequency domain. The second signal may be an NR signal (e.g., a non-low-power signal). The second signal may be transmitted on a same symbol or a same set of symbols, as compared to the first signal, in the frequency domain. The UE may perform an action based at least in part on the first signal. For example, when performing the action, the UE may activate a main radio of the UE based at least in part on the LP-WUS, perform a synchronization based at least in part on the LP-SS, or track one or more of a time, a frequency, or a channel based at least in part on the LP-RS.

In some aspects, in order to support a dual band/tone low-power signal, a low-power signal, such as the first signal, may be transmitted symmetrically across a frequency. The dual band/tone low-power signal may be based at least in part on a frequency domain repetition of the low-power signal. The low-power signal may be transmitted on symmetrical frequencies. By being transmitted on symmetrical frequencies, the low-power signal may be the dual band/tone low-power signal. Such a configuration may be useful for a UE group based low-power signal when different UEs autonomously select their preferred subband to receive the same group low-power signal. Further, such a design may improve a frequency diversity.

In a specific example, in order to support a dual band/tone LP-WUS, the LP-WUS may be transmitted symmetrically across the frequency. The dual band/tone LP-WUS may be based at least in part on the frequency domain repetition of the LP-WUS. The LP-WUS may be transmitted on symmetrical frequencies. By transmitting the LP-WUS on symmetrical frequencies, the LP-WUS may be the dual band/tone LP-WUS. Such a design may be useful for a UE group based LP-WUS when different UEs autonomously select their preferred subband to receive the same group LP-WUS.

FIG. 6 is a diagram illustrating an example 600 associated with dual band signals, in accordance with the present disclosure.

As shown in FIG. 6, an LP-WUS may be transmitted symmetrically across a frequency domain. A first LP-WUS may be transmitted on a first end of a band 1, and a second LP-WUS may be transmitted on a second end of the band 1. The first LP-WUS and the second LP-WUS may be different versions or copies of the same LP-WUS. The first LP-WUS and the second LP-WUS may or may not be separated by an NR signal (associated with another UE) in the frequency domain. The second LP-WUS may be associated with a band 2. The NR signal and the second LP-WUS may be separated by a guard band. The guard band may be associated with a bandwidth equal to band 2.

As indicated above, FIG. 6 is provided as an example. Other examples may differ from what is described with regard to FIG. 6.

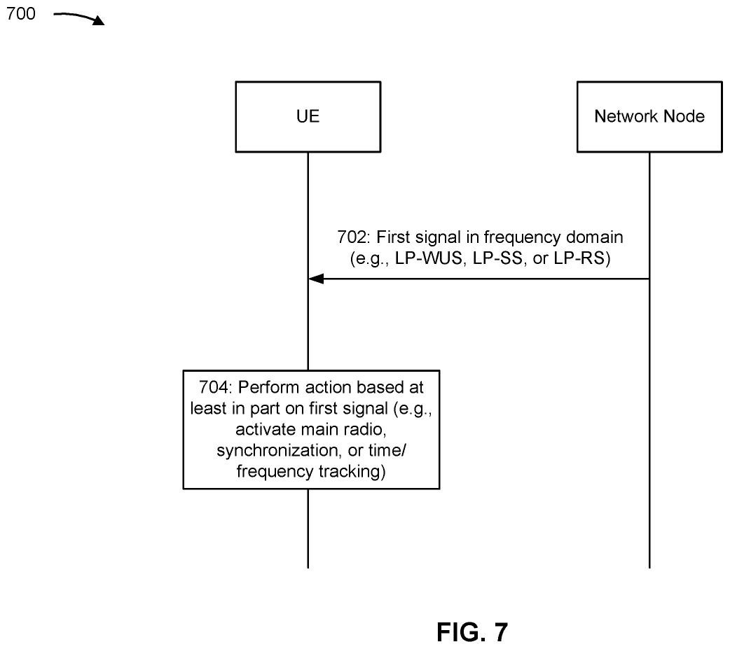

FIG. 7 is a diagram illustrating an example 700 associated with dual band signals, in accordance with the present disclosure. As shown in FIG. 7, example 700 includes communication between a UE (e.g., UE 120) and a network node (e.g., network node 110). In some aspects, the UE and the network node may be included in a wireless network, such as wireless network 100.

As shown by reference number 702, the UE may receive a first signal in a frequency domain. The first signal may be a low-power signal, such as an LP-WUS, an LP-SS, or an LP-RS. The first signal may be a dual band signal that is a function of a second signal transmitted in the frequency domain. The second signal may be an NR signal (e.g., a non-low-power signal). The network node may transmit both the first signal and the second signal in the frequency domain. The network node may transmit the second signal on a same symbol or a same set of symbols, as compared to the first signal, in the frequency domain.

In some aspects, the UE may process the first signal using a bandpass filter (BPF), a mixer, a low pass filter (LPF), or a baseband processor. In some aspects, the UE may process the first signal using an envelope detection, a convolution in the frequency domain, a filtration of the first signal, and/or the baseband processor.

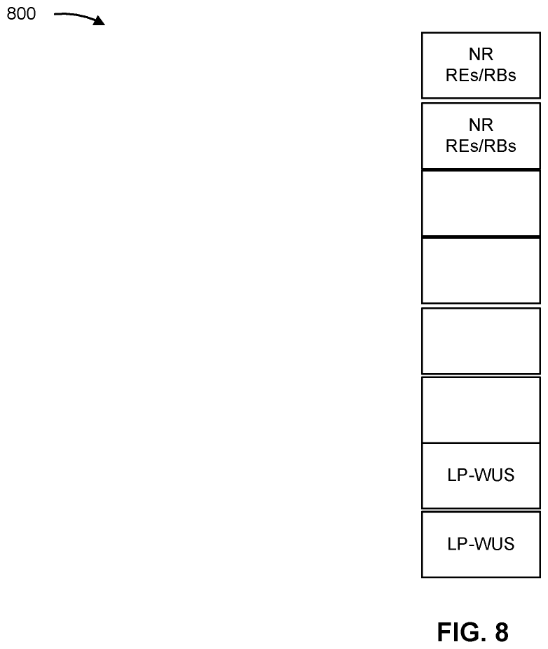

In some aspects, the first signal may be the function of the second signal based at least in part on the first signal being associated with a bit value of “1”. The function may be a non-linear function. The second signal may be associated with a resource element (RE) or a resource block (RB) in the frequency domain (e.g., as shown in FIG. 8). The function may be based at least in part on a conjugate or a repetition of one of: the RE, the RB, a bundle of resources, a bundle of REs, a bundle of RBs, or a subband. The function may be based at least in part on a quantity of REs. RBs, or resources away from the second signal. The function may be based at least in part on a sequence of parameters or values associated with a defined level of energy detection performance or first signal detection at the UE. In some aspects, the first signal may indicate a zero on resources, a low power level, a rate matching, or a puncturing, based at least in part on the dual band signal being associated with a bit value of “0”.

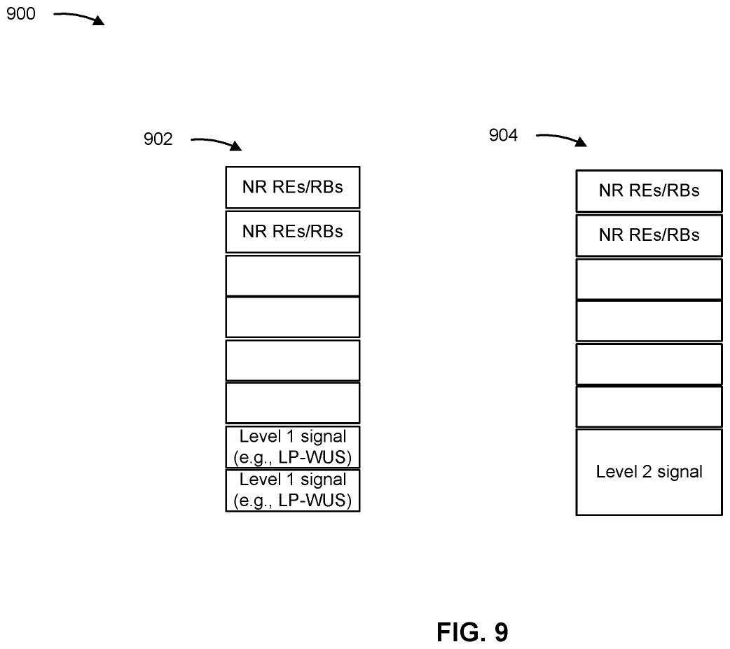

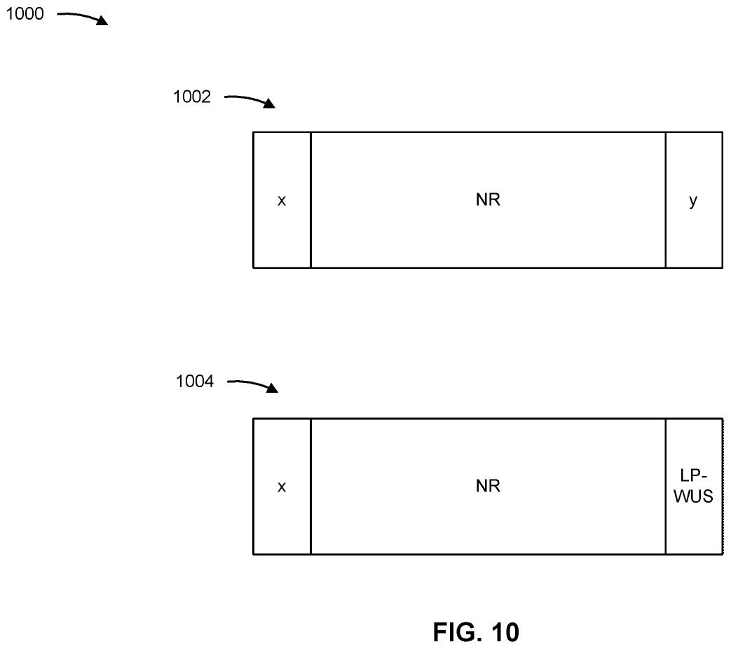

In some aspects, the first signal may be encoded across multiple symbols (e.g., as shown in FIG. 9), and the first signal may be associated with a Manchester coding that is applied across the multiple symbols. In some aspects, the first signal may be associated with an adjustable pulse shape. In some aspects, the first signal is associated with a selectable set of resources within a bandwidth indicated to the UE. In some aspects, the second signal may be associated with a power boosting based at least in part on the first signal being associated with a bit value of “0”, and a power boosting factor may be indicated in one or more of a downlink control information (DCI), an RRC signal, or a MAC control element (MAC-CE). In some aspects, the first signal may indicate a timestamp or a time offset from a previous first signal, and the timestamp or the time offset may be used to compute a time drift of a receiver of the UE (e.g., an LP-WUR), a frequency error of the receiver of the UE, a frequency error associated with a main radio of the UE, or a time drift associated with a main radio clock of the UE. In some aspects, the second signal may be associated with a resource allocation, and an edge of the resource allocation may be used to indicate the first signal (e.g., as shown in FIG. 10).

As shown by reference number 704, the UE may perform an action based at least in part on the first signal. The UE, when performing the action, may activate the main radio of the UE based at least in part on the LP-WUS. The UE, when performing the action, may perform a synchronization based at least in part on the LP-SS. The UE, when performing the action, may track a time, a frequency, and/or a channel based at least in part on the LP-RS.

In some aspects, the UE may be indicated to monitor for signals from the LP-WUR using a layer 1 (L1), a layer 2 (L2), or a layer 3 (L3) indication, and the L1/L2/L3 indication may be to inform of a physical downlink control channel (PDCCH) skipping control signal, a discontinuous reception (DRX) MAC-CE, or an RRC release. A search space set group (SSSG) or a dummy SSG state may be defined, where indicating that SSSG may be an indication to start monitoring the LP-WUR's signals (e.g., LP-WUS, LP-SS, and/or LP-RS). The UE may start to monitor control signals (and other signals) using the LP-WUR.

As indicated above, FIG. 7 is provided as an example. Other examples may differ from what is described with regard to FIG. 7.

In some aspects, when a UE is performing an RF energy detection, the UE may obtain a square of an LP-WUS, which may be equivalent to a convolution in a frequency domain, and which may cause the LP-WUS to move to an IF or a zero IF. Then, a BPF or a mixer may be needed (with a relatively low rate), and then followed by an LPF, which may result in a processed LP-WUS. The UE may make a decision (e.g., turn on a main radio) based at least in part on the processed LP-WUS.

In some aspects, the UE may process the LP-WUS. A processing may involve an RF BPF to filter a band of interest with bandwidth B1. The processing may involve an RF BPF to filter the LP-WUS and an NR signal with band 2, or an RF BPF for only a part, such as a one-half BPF (e.g., no need for an NR section since the NR section may be common for “0” and “1” bit) with band 2. When an RF BPF is used for the LP-WUS and the NR signal, then a mixer may be used to take a resulting signal to baseband. A processing may involve an LPF. The processing may involve a baseband processing to perform a decision on the LP-WUS payload/message/sequence.

In some aspects, the UE may process the LP-WUS. The UE may perform an envelope detection to obtain |X(t)|\hat{ }2, where X(t) is a time domain signal associated with the LP-WUS. The UE may perform a convolution in a frequency domain. The UE may perform a filtration of the LP-WUS after the convolution in the frequency domain. The UE may perform a decision on the LP-WUS payload/message/sequence.

In some aspects, the UE may include an LP-WUR that is capable of DFT. The UE, via the LP-WUR, may take the LP-WUS to the frequency domain. The UE, via the LP-WUR, may detect or filter the LP-WUS. The UE, via the LP-WUR, may process the LP-WUS using either the LP-WUS, or using both the LP-WUS and the NR signal.

In some aspects, one LP-WUS (or an LP-RS or an LP-SS) subband may be a function F( ) of an existing signal subband (e.g., another signal transmitted on a same OFDM symbol or a bundle/set of OFDM symbols). The function may be a linear function or a non-linear function. The function may be defined in a specification or per configuration. For a modulation, when the LP-WUS bit is “1”, a network node may transmit F(X), where X is the NR signal on band 2. For the modulation, when the LP-WUS is “0”, the network node may transmit a low-power signal, a “0”, or a punctured signal. When another UE uses this signal, then the network node may indicate to the UE a puncture or a rate match to remove this resource from its own signal, regardless of whether this is data or a reference signal for a legacy UE. In some cases, instead of puncturing or sending zero on resources, the network node may use lower power levels, and legacy UEs that should decode or receive this signal may be aware of the lower power levels. When data, a zero-power channel state information reference signal (ZP-CSI-RS) may be used to indicate rate matching or puncturing. Further, the UE (a receiver side) may perform a filtration to obtain its LP-WUS.

In some aspects, the function may be associated with a conjugate of an NR RE, an NR RB, a bundle of resources, a bundle of NR REs, a bundle of NR RBs, or a subband. The function may be associated with a repetition of an NR RE, an NR RB, a bundle of resources, a bundle of NR REs, a bundle of NR RBs, or a subband. The function may be associated with a delta (e.g., one or two or X NR REs/RBs/resources) from the NR signal. The delta may be associated with a conjugate, or may be a complex value optimized by the network node. The function may be associated with a sinc signal in the frequency domain, or a sinc signal multiplied by an NR part, which may then be inserted as an LP-WUS part. The function may be associated with a short rect (rectangular) signal (e.g., few resources/REs/RBs) multiplied by the NR signal, or a rect signal as the LP-WUS when “1” and nothing or low power if “0”. The function may be associated with a part of the NR signal, where only one or few REs, RBs, or set of resources may be used and remaining REs, RBs, or resources may be set to zero or to a low power level (e.g., a very low power level). The function may be based on any optimized sequence of complex parameters/values to achieve a certain performance of energy detection or LP-WUS detection at the LP-WUR.

FIG. 8 is a diagram illustrating an example 800 associated with dual band signals, in accordance with the present disclosure.

As shown in FIG. 8, a frequency domain may be associated with one or more NR REs/RBs and one or more LP-WUSs. For example, the frequency domain may include first NR/REs/RBs, second NR REs/RBs, a first LP-WUS, and a second LP-WUS. One LP-WUS (or LP-RS or LP-SS) subband may be a function of an existing signal subband, which may be associated with the one or more NR REs/RBs. In other words, the LP-WUS may be a function of the NR REs/RBs. The function may be a linear function or a non-linear function (e.g., a conjugate). For example, the first LP-WUS may be a conjugate of the first NR/REs/RBs, and the second LP-WUS may be a conjugate of the second NR/REs/RBs.

As indicated above, FIG. 8 is provided as an example. Other examples may differ from what is described with regard to FIG. 8.

FIG. 9 is a diagram illustrating an example 900 associated with dual band signals, in accordance with the present disclosure.

A network node may transmit an LP-WUS across multiple bits. As shown by reference number 902, the network node may transmit an LP-WUS of “1”. The network node may transmit a signal that is associated with NR REs/RBs and the LP-WUS. In one example, the network node may transmit a level 1 signal (e.g., the LP-WUS), which may be a function (e.g., a conjugate) of the NE REs/RBs. The level 1 signal may be at a same power level as an NR signal associated with the NE REs/RBs. As shown by reference number 904, the network node may transmit a “0” (e.g., no LP-WUS). In this case, the network node may transmit a signal that is only associated with NR REs/RBs and not the LP-WUS. In one example, the network node may transmit a level 2 signal. The level 2 signal may be associated with a zero in baseband (e.g., the level 2 signal may represent zero in baseband), or the level 2 signal may be a zero power signal, which may be seen as the NR REs/RBs being multiplied with zero.

As indicated above, FIG. 9 is provided as an example. Other examples may differ from what is described with regard to FIG. 9.

In some aspects, a network node may adjust a pulse shape, such that the pulse shape may have a certain value or shape at a UE side (or receiver side). For example, for RF energy detection, a received signal may be |X(t)|\hat{ }2, where X(t) is a time domain signal associated with an LP-WUS. In some aspects, the network node may perform a power boosting to an NR signal when the LP-WUS is zero bits (e.g., when no LP-WUS is transmitted). The network node may not perform the power boosting to the NR signal when the LP-WUS is one bit. In some aspects, legacy UEs may be notified of a power boosting factor, if any, for NR signals. The network node may indicate the power boosting factor in a scheduling DCI, an RRC signaling, and/or a MAC-CE. The power boosting factor may be indicated via the RRC signaling or the MAC-CE, and then DCI may indicate a bitmap used for applying the power boosting (or transmit an LP-WUS payload, which may not be needed at the legacy UEs, but the legacy UEs should be notified when power boosting is applied). The power boosting factor may also be signaled in DCI.

In some aspects, the network node may select any set of resources (or signal) to repeat as the LP-WUS, which may include using an SSB or any signal, and not necessarily an edge signal. For example, resources used to repeat the LP-WUS may not necessarily be resources associated with an edge of a band. Rather, the resources used to repeat the LP-WUS may be anywhere within the band. The UE may filter across the set of resources. In some aspects, a bandwidth associated with the set of resources may be indicated or known by the UE.

In some aspects, the LP-WUS (or an LP-SS, an LP-RS, a low-power signal, or a preamble in the LP-WUS) may carry a timestamp or a time offset from a previous LP-WUS, a previous LP-RS/LP-SS, or a previous reference signal used by a main radio of the UE. The timestamp may be used to compute a time drift of an LP-WUR. The timestamp may be used to compute a frequency error of the LP-WUR. The timestamp may be used to compute a frequency error of the main radio. The timestamp may be used to compute a time drift of a main radio clock. Further, the timestamp may assist with a synchronization of the main radio.

In some aspects, the network node may apply Manchester coding. The network node may apply Manchester coding across multiple OFDM symbols or the same OFDM symbol. The network node may modulate sub-carriers of the OFDM symbols to transmit M bits using OOK or phase-shift keying (FSK).

In some aspects, an NR signal may have x and y as signals at edges of the allocations (legacy UE signal). To add the LP-WUS for the LP-WUR, data of another UE (e.g., a legacy UE) may be punctured or partially used. The LP-WUS may be with or without a guard band. When transmitting “1”, the LP-WUS will be x (or x conjugate (x*)). When transmitting “0”, the LP-WUS may be the same as y, which may not be legacy UE data (so legacy UE will not be impacted). Alternatively, when transmitting “0”, the LP-WUS may be zero (e.g., no transmission), low power, or a puncture. When there is data, a ZP-CSI-RS may be used to indicate rate matching or puncturing.

FIG. 10 is a diagram illustrating an example 1000 associated with dual band signals, in accordance with the present disclosure.

As shown by reference number 1002, an NR signal may have x and y as signals at edges of the allocations (e.g., legacy UE signals). As shown by reference number 1004, the network node may transmit an LP-WUS in place of the y signal at the edge of the allocation. The LP-WUS may be a repetition of x or a conjugate of x (e.g., when LP-WUS is “1”). Alternatively, the LP-WUS may be the same as y, or the LP-WUS may be zero, low power, or a puncture (e.g., when LP-WUS is “0”).

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 120) performs operations associated with dual band signals.

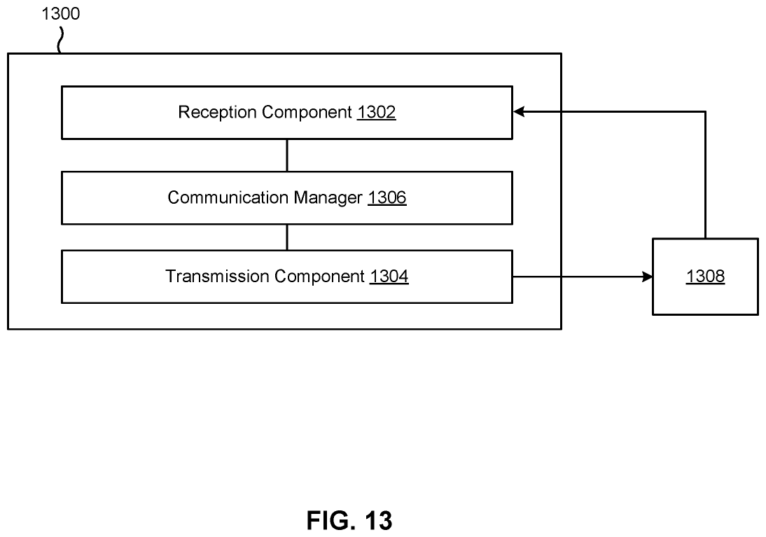

As shown in FIG. 11, in some aspects, process 1100 may include receiving a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal (block 1110). For example, the UE (e.g., using reception component 1302 and/or communication manager 1306, depicted in FIG. 13) may receive a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal, as described above.

As further shown in FIG. 11, in some aspects, process 1100 may include performing an action based at least in part on the first signal (block 1120). For example, the UE (e.g., using communication manager 1306, depicted in FIG. 13) may perform an action based at least in part on the first signal, as described above.

Process 1100 may include additional aspects, such as any single aspect or any combination of aspects described below and/or in connection with one or more other processes described elsewhere herein.

In a first aspect, the first signal is one of an LP-WUS, an LP-SS, or an LP-RS.

In a second aspect, alone or in combination with the first aspect, process 1100 includes activating a main radio of the UE based at least in part on the LP-WUS, performing a synchronization based at least in part on the LP-SS, or tracking one or more of a time, a frequency, or a channel based at least in part on the LP-RS.

In a third aspect, alone or in combination with one or more of the first and second aspects, the first signal is the function of the second signal based at least in part on a first signal bit being a value of “1”.

In a fourth aspect, alone or in combination with one or more of the first through third aspects, the first signal indicates a zero on resources, a rate matching or a puncturing.

In a fifth aspect, alone or in combination with one or more of the first through fourth aspects, process 1100 includes processing the first signal using one or more of a bandpass filter, a mixer, a low pass filter, or a baseband processor, or processing the first signal using one or more of an envelope detection, a convolution in the frequency domain, a filtration of the first signal, or the baseband processor.

In a sixth aspect, alone or in combination with one or more of the first through fifth aspects, the function is a non-linear function.

In a seventh aspect, alone or in combination with one or more of the first through sixth aspects, the second signal is received using a resource element (RE) or a resource block (RB) in the frequency domain.

In an eighth aspect, alone or in combination with one or more of the first through seventh aspects, the function is based at least in part on a conjugate or a repetition of one of the RE, the RB, a bundle of resources, a bundle of REs, a bundle of RBs, or a subband.

In a ninth aspect, alone or in combination with one or more of the first through eighth aspects, the function is based at least in part on a quantity of REs, RBs, or resources away from the second signal.

In a tenth aspect, alone or in combination with one or more of the first through ninth aspects, the function is based at least in part on a sequence of parameters or values associated with a defined level of energy detection performance or first signal detection at the UE.

In an eleventh aspect, alone or in combination with one or more of the first through tenth aspects, the first signal is encoded across multiple symbols, and the first signal is associated with a Manchester coding that is applied across the multiple symbols.

In a twelfth aspect, alone or in combination with one or more of the first through eleventh aspects, the first signal is associated with an adjustable pulse shape.

In a thirteenth aspect, alone or in combination with one or more of the first through twelfth aspects, the second signal is associated with a power boosting based at least in part on the first signal being associated with a bit value of “0”, and a power boosting factor is indicated in one or more of a DCI, an RRC signal, or a MAC-CE.

In a fourteenth aspect, alone or in combination with one or more of the first through thirteenth aspects, the first signal is associated with a selectable set of resources within a bandwidth indicated to the UE.

In a fifteenth aspect, alone or in combination with one or more of the first through fourteenth aspects, the first signal indicates a timestamp or a time offset from a previous first signal, and the timestamp or the time offset is used to compute one or more of: a time drift of a receiver of the UE, a frequency error of the receiver of the UE, a frequency error associated with a main radio of the UE, or a time drift associated with a main radio clock of the UE.

In a sixteenth aspect, alone or in combination with one or more of the first through fifteenth aspects, the second signal is associated with a resource allocation, and an edge of the resource allocation is used to indicate the first signal.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with dual band signals.

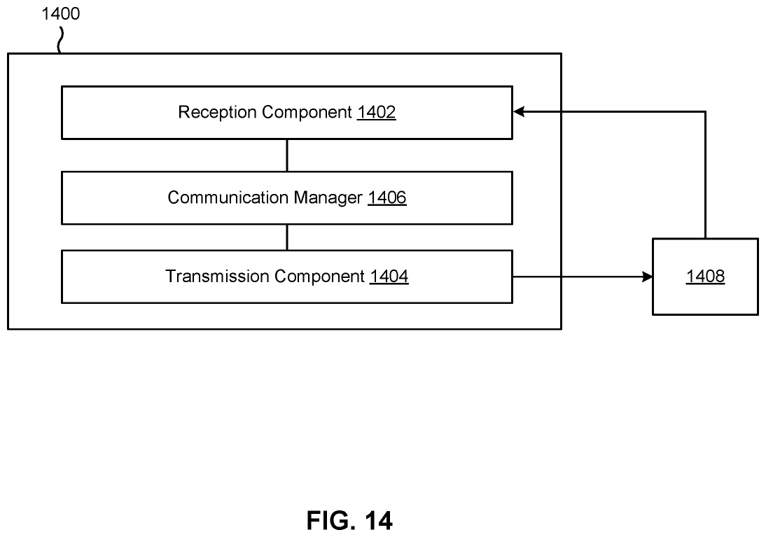

As shown in FIG. 12, in some aspects, process 1200 may include transmitting a first signal in a frequency domain (block 1210). For example, the network node (e.g., using transmission component 1404 and/or communication manager 1406, depicted in FIG. 14) may transmit a first signal in a frequency domain, as described above.

As further shown in FIG. 12, in some aspects, process 1200 may include transmitting a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal (block 1220). For example, the network node (e.g., using transmission component 1404 and/or communication manager 1406, depicted in FIG. 14) may transmit a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal, as described above.

Process 1200 may include additional aspects, such as any single aspect or any combination of aspects described below and/or in connection with one or more other processes described elsewhere herein.

In a first aspect, the second signal is one of an LP-WUS, an LP-SS, or an LP-RS.

In a second aspect, alone or in combination with the first aspect, the second signal is the function of the first signal based at least in part on a second signal bit being a value of “1”.

In a third aspect, alone or in combination with one or more of the first and second aspects, the second signal indicates a zero on resources, a rate matching or a puncturing.

In a fourth aspect, alone or in combination with one or more of the first through third aspects, the function is a non-linear function.

In a fifth aspect, alone or in combination with one or more of the first through fourth aspects, process 1200 includes transmitting the first signal using an RE or an RB in the frequency domain.

In a sixth aspect, alone or in combination with one or more of the first through fifth aspects, the function is based at least in part on a conjugate or a repetition of one of the RE, the RB, a bundle of resources, a bundle of REs, a bundle of RBs, or a subband.

In a seventh aspect, alone or in combination with one or more of the first through sixth aspects, the function is based at least in part on a quantity of REs, RBs, or resources away from the first signal.

In an eighth aspect, alone or in combination with one or more of the first through seventh aspects, the function is based at least in part on a sequence of parameters or values associated with a defined level of energy detection performance or first signal detection at a UE.

In a ninth aspect, alone or in combination with one or more of the first through eighth aspects, the second signal is encoded across multiple symbols, and the second signal is associated with a Manchester coding that is applied across the multiple symbols.

In a tenth aspect, alone or in combination with one or more of the first through ninth aspects, the second signal is associated with an adjustable pulse shape.

In an eleventh aspect, alone or in combination with one or more of the first through tenth aspects, the first signal is associated with a power boosting based at least in part on the second signal being associated with a bit value of “0”, and a power boosting factor is indicated in one or more of a DCI, an RRC signal, or a MAC-CE.

In a twelfth aspect, alone or in combination with one or more of the first through eleventh aspects, the second signal is associated with a selectable set of resources within a bandwidth indicated to the UE.

In a thirteenth aspect, alone or in combination with one or more of the first through twelfth aspects, the second signal indicates a timestamp or a time offset from a previous second signal, and the timestamp or the time offset is used to compute one or more of a time drift of a receiver of the UE, a frequency error of the receiver of the UE, a frequency error associated with a main radio of the UE, or a time drift associated with a main radio clock of the UE.

In a fourteenth aspect, alone or in combination with one or more of the first through thirteenth aspects, the first signal is associated with a resource allocation, and an edge of the resource allocation is used to indicate the second signal.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 6-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal. The communication manager 1306 may perform an action based at least in part on the first signal. The communication manager 1306 may process the first signal using one or more of: a bandpass filter, a mixer, a low pass filter, or a baseband processor. The communication manager 1306 may process the first signal using one or more of: an envelope detection, a convolution in the frequency domain, a filtration of the first signal, or the baseband processor.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 6-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit a first signal in a frequency domain. The transmission component 1404 may transmit a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal; and performing an action based at least in part on the first signal.

Aspect 2: The method of Aspect 1, wherein the first signal is one of: a low-power wakeup signal (LP-WUS), a low-power synchronization signal (LP-SS), or a low-power reference signal (LP-RS).

Aspect 3: The method of Aspect 2, wherein performing the action comprises: activating a main radio of the UE based at least in part on the LP-WUS; performing a synchronization based at least in part on the LP-SS; or tracking one or more of a time, a frequency, or a channel based at least in part on the LP-RS.

Aspect 4: The method of any of Aspects 1-3, wherein the first signal is the function of the second signal based at least in part on a first signal bit being a value of “1”.

Aspect 5: The method of any of Aspects 1-4, wherein the first signal indicates a zero on resources, a rate matching or a puncturing.

Aspect 6: The method of any of Aspects 1-5, further comprising: processing the first signal using one or more of: a bandpass filter, a mixer, a low pass filter, or a baseband processor; or processing the first signal using one or more of: an envelope detection, a convolution in the frequency domain, a filtration of the first signal, or the baseband processor.

Aspect 7: The method of any of Aspects 1-6, wherein the function is a non-linear function.

Aspect 8: The method of any of Aspects 1-7, wherein the second signal is received using a resource element (RE) or a resource block (RB) in the frequency domain.

Aspect 9: The method of Aspect 8, wherein the function is based at least in part on a conjugate or a repetition of one of: the RE, the RB, a bundle of resources, a bundle of REs, a bundle of RBs, or a subband.

Aspect 10: The method of Aspect 8, wherein the function is based at least in part on a quantity of REs, RBs, or resources away from the second signal.

Aspect 11: The method of any of Aspects 1-10, wherein the function is based at least in part on a sequence of parameters or values associated with a defined level of energy detection performance or first signal detection at the UE.

Aspect 12: The method of any of Aspects 1-11, wherein the first signal is encoded across multiple symbols, and the first signal is associated with a Manchester coding that is applied across the multiple symbols.

Aspect 13: The method of any of Aspects 1-12, wherein the first signal is associated with an adjustable pulse shape.

Aspect 14: The method of any of Aspects 1-13, wherein the second signal is associated with a power boosting based at least in part on the first signal being associated with a bit value of “0”, and a power boosting factor is indicated in one or more of a downlink control information (DCI), a radio resource control (RRC) signal, or a medium access control control element (MAC-CE).

Aspect 15: The method of any of Aspects 1-14, wherein the first signal is associated with a selectable set of resources within a bandwidth indicated to the UE.

Aspect 16: The method of any of Aspects 1-15, wherein the first signal indicates a timestamp or a time offset from a previous first signal, and the timestamp or the time offset is used to compute one or more of: a time drift of a receiver of the UE, a frequency error of the receiver of the UE, a frequency error associated with a main radio of the UE, or a time drift associated with a main radio clock of the UE.

Aspect 17: The method of any of Aspects 1-16, wherein the second signal is associated with a resource allocation, and an edge of the resource allocation is used to indicate the first signal.

Aspect 18: A method of wireless communication performed by a network node, comprising: transmitting a first signal in a frequency domain; and transmitting a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal.

Aspect 19: The method of Aspect 18, wherein the second signal is one of: a low-power wakeup signal (LP-WUS), a low-power synchronization signal (LP-SS), or a low-power reference signal (LP-RS).

Aspect 20: The method of any of Aspects 18-19, wherein the second signal is the function of the first signal based at least in part on a second signal bit being a value of “1”.

Aspect 21: The method of any of Aspects 18-20, wherein the second signal indicates a zero on resources, a rate matching or a puncturing.

Aspect 22: The method of any of Aspects 18-21, wherein the function is a non-linear function.

Aspect 23: The method of any of Aspects 18-22, wherein the first signal is transmitted using a resource element (RE) or a resource block (RB) in the frequency domain.

Aspect 24: The method of Aspect 23, wherein the function is based at least in part on a conjugate or a repetition of one of: the RE, the RB, a bundle of resources, a bundle of REs, a bundle of RBs, or a subband.

Aspect 25: The method of Aspect 23, wherein the function is based at least in part on a quantity of REs. RBs, or resources away from the first signal.

Aspect 26: The method of any of Aspects 18-25, wherein the function is based at least in part on a sequence of parameters or values associated with a defined level of energy detection performance or second signal detection at a user equipment (UE).

Aspect 27: The method of any of Aspects 18-26, wherein the second signal is encoded across multiple symbols, and the second signal is associated with a Manchester coding that is applied across the multiple symbols.

Aspect 28: The method of any of Aspects 18-27, wherein the second signal is associated with an adjustable pulse shape.

Aspect 29: The method of any of Aspects 18-28, wherein the first signal is associated with a power boosting based at least in part on the second signal being associated with a bit value of “0”, and a power boosting factor is indicated in one or more of a downlink control information (DCI), a radio resource control (RRC) signal, or a medium access control control element (MAC-CE).

Aspect 30: The method of any of Aspects 18-29, wherein the second signal is associated with a selectable set of resources within a bandwidth indicated to the UE.

Aspect 31: The method of any of Aspects 18-30, wherein the second signal indicates a timestamp or a time offset from a previous second signal, and the timestamp or the time offset is used to compute one or more of: a time drift of a receiver of a user equipment (UE), a frequency error of the receiver of the UE, a frequency error associated with a main radio of the UE, or a time drift associated with a main radio clock of the UE.

Aspect 32: The method of any of Aspects 18-31, wherein the first signal is associated with a resource allocation, and an edge of the resource allocation is used to indicate the second signal.

Aspect 33: An apparatus for wireless communication at a device, comprising a processor; memory coupled with the processor; and instructions stored in the memory and executable by the processor to cause the apparatus to perform the method of one or more of Aspects 1-17.

Aspect 34: A device for wireless communication, comprising a memory and one or more processors coupled to the memory, the one or more processors configured to perform the method of one or more of Aspects 1-17.

Aspect 35: An apparatus for wireless communication, comprising at least one means for performing the method of one or more of Aspects 1-17.

Aspect 36: A non-transitory computer-readable medium storing code for wireless communication, the code comprising instructions executable by a processor to perform the method of one or more of Aspects 1-17.

Aspect 37: A non-transitory computer-readable medium storing a set of instructions for wireless communication, the set of instructions comprising one or more instructions that, when executed by one or more processors of a device, cause the device to perform the method of one or more of Aspects 1-17.

Aspect 38: An apparatus for wireless communication at a device, comprising a processor; memory coupled with the processor; and instructions stored in the memory and executable by the processor to cause the apparatus to perform the method of one or more of Aspects 18-32.

Aspect 39: A device for wireless communication, comprising a memory and one or more processors coupled to the memory, the one or more processors configured to perform the method of one or more of Aspects 18-32.

Aspect 40: An apparatus for wireless communication, comprising at least one means for performing the method of one or more of Aspects 18-32.

Aspect 41: A non-transitory computer-readable medium storing code for wireless communication, the code comprising instructions executable by a processor to perform the method of one or more of Aspects 18-32.

Aspect 42: A non-transitory computer-readable medium storing a set of instructions for wireless communication, the set of instructions comprising one or more instructions that, when executed by one or more processors of a device, cause the device to perform the method of one or more of Aspects 18-32.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors coupled with the memory and configured to cause the UE to:
receive a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal; and
perform an action based at least in part on the first signal.

2. The UE of claim 1, wherein the first signal is one of: a low-power wakeup signal (LP-WUS), a low-power synchronization signal (LP-SS), or a low-power reference signal (LP-RS).

3. The UE of claim 2, wherein the one or more processors, to perform the action, are configured to cause the UE to:
activate a main radio of the UE based at least in part on the LP-WUS;
perform a synchronization based at least in part on the LP-SS; or
track one or more of a time, a frequency, or a channel based at least in part on the LP-RS.

4. The UE of claim 1, wherein the first signal is the function of the second signal based at least in part on a first signal bit being a value of “1”.

5. The UE of claim 1, wherein the first signal indicates a zero on resources, a rate matching or a puncturing.

6. The UE of claim 1, wherein the one or more processors are further configured to cause the UE to:
process the first signal using one or more of: a bandpass filter, a mixer, a low pass filter, or a baseband processor; or
process the first signal using one or more of: an envelope detection, a convolution in the frequency domain, a filtration of the first signal, or the baseband processor.

7. The UE of claim 1, wherein the function is a non-linear function.

8. The UE of claim 1, wherein the second signal is received using a resource element (RE) or a resource block (RB) in the frequency domain.

9. The UE of claim 8, wherein the function is based at least in part on a conjugate or a repetition of one of: the RE, the RB, a bundle of resources, a bundle of REs, a bundle of RBs, or a subband.

10. The UE of claim 8, wherein the function is based at least in part on a quantity of REs, RBs, or resources away from the second signal.

11. The UE of claim 1, wherein the function is based at least in part on a sequence of parameters or values associated with a defined level of energy detection performance or first signal detection at the UE.

12. The UE of claim 1, wherein the first signal is encoded across multiple symbols, and the first signal is associated with a Manchester coding that is applied across the multiple symbols.

13. The UE of claim 1, wherein the first signal is associated with an adjustable pulse shape.

14. The UE of claim 1, wherein the second signal is associated with a power boosting based at least in part on the first signal being associated with a bit value of “0”, and a power boosting factor is indicated in one or more of a downlink control information (DCI), a radio resource control (RRC) signal, or a medium access control control element (MAC-CE).

15. The UE of claim 1, wherein the first signal is associated with a selectable set of resources within a bandwidth indicated to the UE.

16. The UE of claim 1, wherein the first signal indicates a timestamp or a time offset from a previous first signal, and the timestamp or the time offset is used to compute one or more of: a time drift of a receiver of the UE, a frequency error of the receiver of the UE, a frequency error associated with a main radio of the UE, or a time drift associated with a main radio clock of the UE.

17. The UE of claim 1, wherein the second signal is associated with a resource allocation, and an edge of the resource allocation is used to indicate the first signal.

18. A network node for wireless communication, comprising:
a memory; and
one or more processors coupled with the memory and configured to cause the network node to:
transmit a first signal in a frequency domain; and
transmit a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal.

19. The network node of claim 18, wherein the second signal is one of: a low-power wakeup signal (LP-WUS), a low-power synchronization signal (LP-SS), or a low-power reference signal (LP-RS).

20. The network node of claim 18, wherein the second signal is the function of the first signal based at least in part on a second signal bit being a value of “1”.

21. The network node of claim 18, wherein the second signal indicates a zero on resources, a rate matching or a puncturing.

22. The network node of claim 18, wherein:
the function is a non-linear function;
the function is based at least in part on a sequence of parameters or values associated with a defined level of energy detection performance or second signal detection at a user equipment (UE); or
the second signal is encoded across multiple symbols, and the second signal is associated with a Manchester coding that is applied across the multiple symbols.

23. The network node of claim 18, wherein the first signal is transmitted using a resource element (RE) or a resource block (RB) in the frequency domain.

24. The network node of claim 23, wherein the function is based at least in part on a conjugate or a repetition of one of: the RE, the RB, a bundle of resources, a bundle of REs, a bundle of RBs, or a subband.

25. The network node of claim 23, wherein the function is based at least in part on a quantity of REs, RBs, or resources away from the first signal.

26. The network node of claim 18, wherein:
the second signal is associated with an adjustable pulse shape;
the second signal is associated with a selectable set of resources within a bandwidth indicated to a user equipment (UE); or
the NR signal is associated with a resource allocation, and an edge of the resource allocation is used to indicate the second signal.

27. The network node of claim 18, wherein the first signal is associated with a power boosting based at least in part on the second signal being associated with a bit value of “0”, and a power boosting factor is indicated in one or more of a downlink control information (DCI), a radio resource control (RRC) signal, or a medium access control control element (MAC-CE).

28. The network node of claim 18, wherein the second signal indicates a timestamp or a time offset from a previous second signal, and the timestamp or the time offset is used to compute one or more of: a time drift of a receiver of a user equipment (UE), a frequency error of the receiver of the UE, a frequency error associated with a main radio of the UE, or a time drift associated with a main radio clock of the UE.

29. A method of wireless communication performed by a user equipment (UE), comprising:
receiving a first signal in a frequency domain, the first signal being a dual band signal that is a function of a second signal transmitted in the frequency domain, the second signal being transmitted on a same symbol or a same set of symbols as the first signal in the frequency domain, and the first signal having a lower transmission power than the second signal; and
performing an action based at least in part on the first signal.

30. A method of wireless communication performed by a network node, comprising:
transmitting a first signal in a frequency domain; and
transmitting a second signal in the frequency domain, the second signal being a dual band signal that is a function of the first signal transmitted in the frequency domain, the second signal being transmitted on a same symbol or a same set of symbols as the first signal in the frequency domain, and the second signal having a lower transmission power than the first signal.
